(19) United States
(12) Patent Application Publication
(10) Pub. No.: US 2008/0244399 A1
(43) Pub. Date: Oct. 2, 2008

(54) CONTEXTUAL SUPPORT CENTER

(75) Inventors: Peer Hilgers, St. Leon-Rot (DE); Leif Jensen-Pistorius, Oestringen (DE)

Correspondence Address: SCHWEGMAN, LUNDBERG & WOESSNER/SAP, P.O. BOX 2938, MINNEAPOLIS, MN, 55402, US

(73) Assignee: SAP AG

(21) Appl. No.: 11/692,848

(22) Filed: Mar. 28, 2007

(51) Int. Cl. G06F 3/00

(52) U.S. Cl. 715/708

(57) ABSTRACT

A method and system to provide contextual support data are described. The method may detect an event related to an object associated with an application and presented to a user in a first portion of an interface of the application. In response to detecting of the event, the method may locate support data related to the object, including using contextual information pertaining to the object and to the user. The method may present, in a second portion of the interface, the located support data related to the object. The detecting of the event may include a user interaction with the interface of the application. The contextual support system may include a user interface module, a detection module, a look-up module, a database and a database server. The support data may also be contextual to a person or an attribute of the person.

### TECHNICAL FIELD

An embodiment relates generally to the field of computer software. In particular, the example embodiment relates to a method and system to provide contextual support in an application.

### BACKGROUND

With technological advancements, software packages are playing a dominant role in planning, managing, and implementing tasks in almost all areas including science and technology, business, entertainment, education, manufacturing, etc. Access to information is a prominent factor in warranting success and efficiency in any endeavor. Recent developments in high-speed Internet technology and networking have revolutionized access to information for all tiers of users. People may find Internet access devices in almost every corner of their work environments as well as other public and private places. Many handheld communication devices are also providing access to Internet.

Workers in many business enterprises, manufacturing facilities, health services, government agencies, and the like use many software packages when performing professional tasks. Moreover, using software packages for handling daily life activities such as financial planning, filing taxes, interior design, and landscape design is becoming more popular

Most software application developers are aware that the users may need additional information while handling their tasks. The additional information may be related to the task itself or resources and people associated with the task. For example, a secretary typing a letter may need the contact information of the person who has ordered the task or the mailing address of the addressee of the letter.

Resources for this type of information, if provided in a software package, may include Internet access, search tools, and favorites, which may be provided through a portal page of the application.

### BRIEF DESCRIPTION OF THE DRAWINGS

Some embodiments are illustrated by way of example and not limitation in the figures of the accompanying drawings in which:

FIG. 1 is a high-level diagram, illustrating an example graphical user interface including an application area and a supplemental area for displaying contextual support data;

FIG. 2 is a high-level block diagram, illustrating an example embodiment of a system for providing contextual support data in an application;

FIG. 3 is a high-level block diagram, illustrating a further example embodiment of a system for providing contextual support data in an application;

FIG. 4 is a screen shot, illustrating an example embodiment of a graphical user interface including an application area, an object, and a supplemental area divided into a plurality of sections;

FIG. 5 is a block diagram, illustrating example modules included in a contextual support system;

FIG. 6 is a block diagram, illustrating an example embodiment of locating contextual support data related to an object;

FIG. 7 is a block diagram, illustrating an example embodiment of sorting and configuring contextual support data related to an object;

FIG. 8 is a sequential flow diagram, illustrating an example embodiment of transactions between modules of a contextual support system;

FIG. 9 is a flow diagram, illustrating an example embodiment of a method for providing contextual support data in an application;

FIG. 10 shows a screen shot, illustrating an example embodiment of a graphical user interface including a supplemental area configured to display three categories of support data;

FIG. 11 shows a screen shot, illustrating another example embodiment of a graphical user interface including a supplemental area configured to display three categories of support data;

FIG. 12 shows a screen shot, illustrating a further example embodiment of a graphical user interface including a supplemental area configured to display three categories of support data;

FIG. 13 is a flow diagram, illustrating an example embodiment of a method for providing contextual support data in an application, including sorting and configuring the support data;

FIG. 14 is a network diagram depicting a system, according to one example embodiment, having a client-server architecture;

FIG. 15 is a block diagram illustrating enterprise applications and services as embodied in the enterprise application platform, according to an example embodiment; and

FIG. 16 shows an example machine in the form of a computer system to implement any one or more of the methods and/or systems described herein.

### DETAILED DESCRIPTION

A method and system to provide contextual support data are provided. In example embodiments, the method may include detecting an event related to an object associated with an application and presented to a user in a first portion of an interface of the application; responsive to the detecting the event, locating support data related to the object, the locating of the support data including using contextual information pertaining to the object and to the user; and presenting, in a second portion of the interface, the located support data related to the object.

The “support data” may also be referred to as “contextual support data.” The “first portion of the interface” may also be referred to as “application area.” The “second portion of the interface” may also be referred to as “supplemental area,” or “contextual support area.”

In the following description, for purposes of explanation, numerous specific details are set forth in order to provide a thorough understanding of the present embodiment. However, it will be evident to a person of ordinary skill in art that the embodiment may be practiced without these specific details.

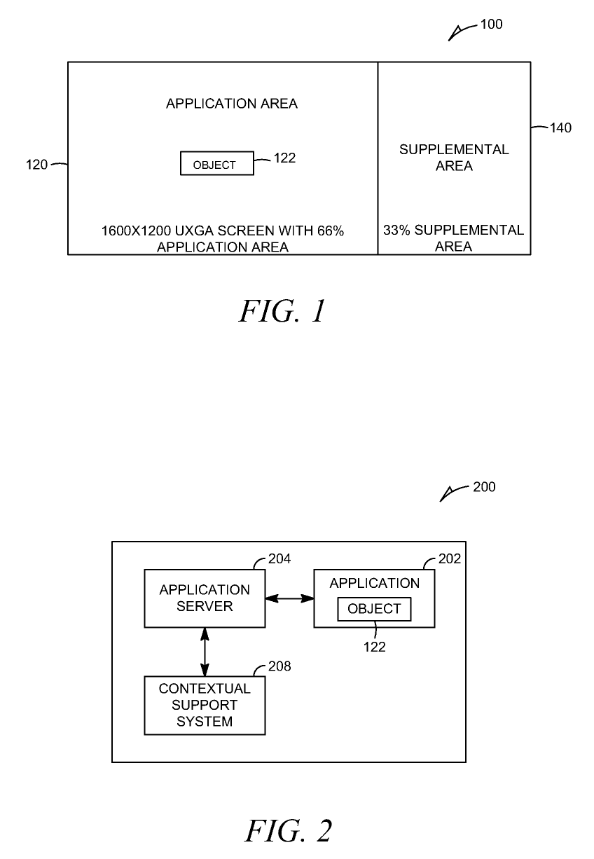

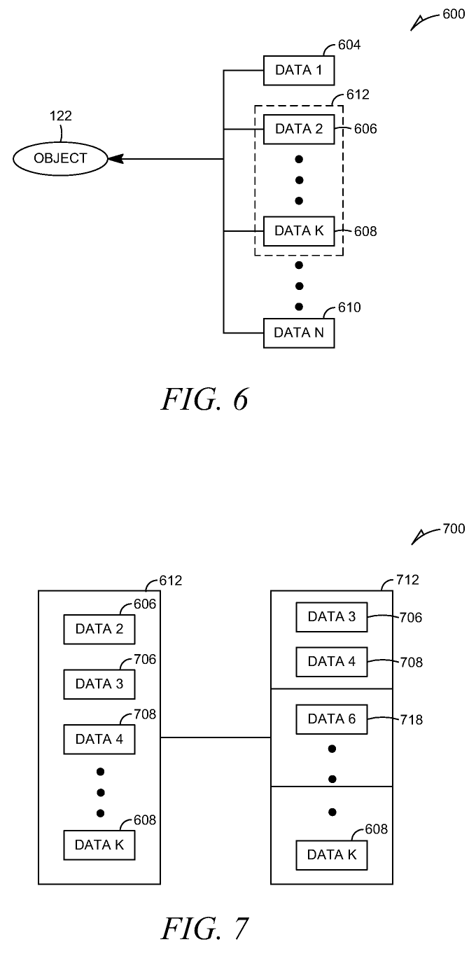

Referring to FIG. 1 of the drawings, reference 100 indicates an example graphical user interface including an application area 120 and a supplemental area 140 for displaying contextual support data 612 (see FIG. 6). The application area 120 may include an object 122 for which contextual support data 612 may be provided in the supplemental area 140.

In one example embodiment, the object 122 may be any item of a group including an attribute of the first portion of the interface, a data item included in the first portion of the interface, a person identified in the first portion of the interface, and a person associated with a data item included in the first portion of the interface.

According to an example embodiment, detecting the event may include detecting a user interaction with the interface of the application. In example embodiments, the event may include a mouseover on object 122 associated with the application area 120; a mouse click over the object 122; pressing a predetermined key (e.g., a function key); receiving a content in a certain box on the application area 120 (e.g. a phone number in an example call center application); receiving a wrong content in a certain box on the application area 120 (e.g., a wrong address or phone number or the like); receiving a predetermined voice message from a user identifying the object (e.g., calling a name of a person to receive a contextual data related to that person, such as a current bill for a service provided to that person).

According to example embodiments, the support data may also be contextual to a person or an attribute of the person (e.g., a task performed by the person, a role of the person in a work place, a role attribute of the person, or a historical data associated with the person). The person may be an agent of a work place, such as but not limited to, a business enterprise, a manufacturing facility, an academic or scientific institution, a health center, or the like. The support data may be contextual data, meta-data, or historical data such as the previous activities of the agent related to his tasks.

Referring to FIG. 2 of the drawings, reference 200 indicates an example embodiment of a system for providing contextual support data in an application. According to an example embodiment, the system may include an application 202, an application server 204, and a contextual support system 208.

The application 202 may include an object 122 for which the contextual support data 612 may be provided in the supplemental area 140 of the application interface 100. In example embodiments, the application may be any software application including, but not limited to, accounting and financial, tax preparation, customer service, engineering simulation, or project management applications. The application 202 may be served by an application server 204, which may also be communicatively connected to the contextual support system 208 described below. The application 202 may use the contextual support system 208 through the application server 204 to receive contextual support data 612 related to the object 122.

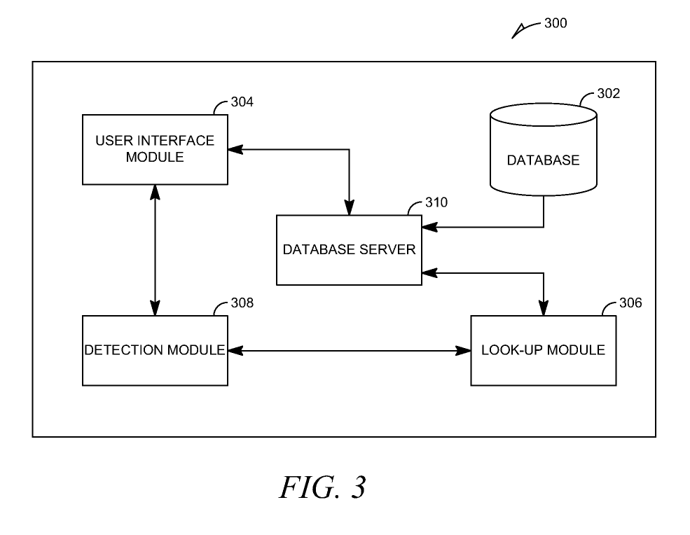

Referring to FIG. 3 of the drawings, reference 300 designates a system for providing contextual support data in an application. In an example embodiment, the system 300 may include a user interface module 304, a detection module 308, a database 302, a database server 310, and a look-up module 306.

In one example embodiment, the user interface module 304 may display the second portion or the supplemental area 140 of the application interface 100 without overlapping the first portion or the application area 120 and in a fixed position relative to the application area 120.

According to an example embodiment, the user interface module 304 may display on the user application interface 100, an application area 120, and a supplemental area 140. The supplemental area 140 may include contextual support data related to an object 122 on the application area 120 or may be contextual to a person (e.g., the user, a task related to the person, such as a task for which the user is using the application, or a role in a work place, such as a job or position in a business or institution whereat the user is employed).

In an example embodiment, the relation between the contextual support data 612 displayed in the supplemental area 140 and the object 122, or the user or attributes of the user, may be dynamic. For example, the relationship between contextual support data related to a customer may not be the same all the time. Not only a portion of the support data related to the customer, e.g. a phone number, may change with time, but the relationship itself may also change. At times, the relationship may be defined as being only contact information of the customer, e.g. if the name of the customer appears in the application area, the contact information may be displayed by the user interface module 304 in the supplemental area 140. This relationship may change or be redefined later; contact information as well as business relationship (e.g., both contact information and the business relationship of the customer) may be displayed in the supplemental area 140.

Returning to FIG. 3, the detection module 308 may detect an event related to the object. In example embodiments, the event may include a mouseover on object 122 of the application area 120; a mouse click over the object 122; pressing a predetermined key, (e.g., a function key); receiving a content in a certain box on the application area 120 (e.g. a phone number in an example call center application); receiving a wrong content in a certain box on the application area 120 (e.g., a wrong address or phone number or the like); receiving a predetermined voice message from a user identifying the object (e.g., calling a name of a person to receive a contextual data related to that person, such as a current bill for a service provided to that person).

According to an example embodiment, the detection module 308 may then identify the object 122 and call on the look-up module 306 to identify the contextual support data related to the object 122, according to a defined relationship, and locate the identified contextual support data on the database 302. The look-up module 306 may use the database server 310 to access the database 302 and locate the identified contextual support data related to the object 122.

In one example embodiment, the user interface module 304 may use the database serve 310 to access the database 302 in order to retrieve data required by the application 202 or store the input data entered by the user of the application 202 and received by the user interface module 304.

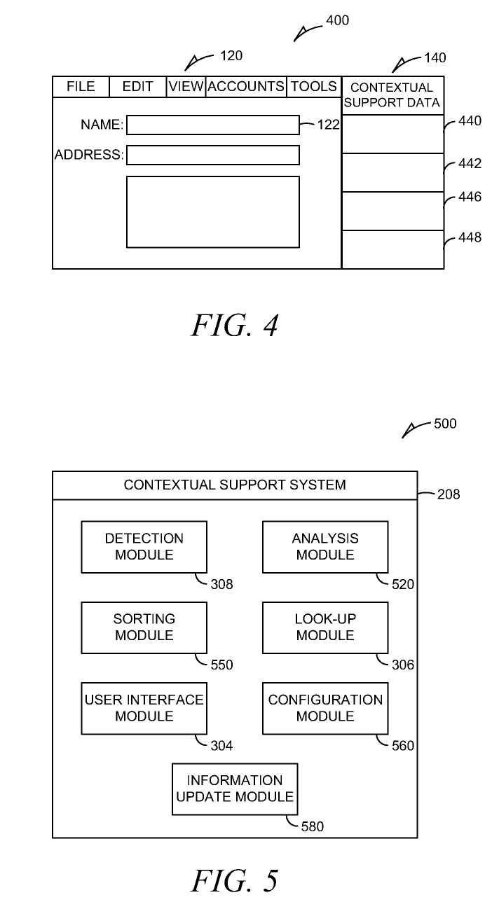

In FIG. 4 of the drawings, reference 400 designates a graphical user interface including an application area 120 embodying an object 122 and a supplemental area 140 divided into a plurality of sections. The object 122 in the example shown is a name, e.g. a customer name.

When this field receives content, the detection module 308 may detect the event and identify the object as being a name. The look-up module 306 locates contextual support data 612 based on a predefined relationship and uses the database server 310 to locate the contextual support data 612 and communicate the located contextual support data 612 to the user interface module 304. The user interface module 304 may then display the received contextual support data 612 in the supplemental area 140 of the application interface 100 of the application 202.

According to an example embodiment, the user interface module 304 may display the contextual data 612 in different example sections 440, 442, 446, or 448 of the supplemental area 140. The sorting and configuring of the contextual support data 612 will be discussed below.

Referring to FIG. 5 of the drawings, reference 500 designates a contextual support system 208, according to an example embodiment. The contextual support system 208, in an example embodiment, may include a detection module 308, a user interface module 304, a look-up module 306, an analysis module 520, a sorting module 550, a configuration module 560, and an information update module 580.

In example embodiments, the user interface module 304 may receive input data entered by the user and communicate the data to the information update module 580. The information update module 580 may use the analysis module 520 to identify in which table of the database 302 the data should be stored The information update module 580 then requests the database server 310 to store the data in the identified table of the database 302, based on the result of the analysis by the analysis module 520. The user interface module 304 may display, an application area 120 and a supplemental area 140 on the application interface 100. The supplemental area 140 may include contextual data related to an object 122 on the application area or may be contextual to a person (e.g., the user), a task related to the person (e.g., a task for which the user is using the application, or a role in a workplace, such as a job or position in a business or institution whereat the user is employed).

The descriptions of the detection module 308 and the look-up module 306 are the same as explained before with respect to FIG. 3. In an example embodiment, the detection module 308 may, upon detection of an event related to the object 122 associated with the application 202, identify the object 122 and cause the look-up module 306 to identify the contextual support data 612 related to the object 122, according to a defined relationship, and locate the identified contextual support data 612 on the database 302. The look-up module 306 may use the database server 310 to access the database 302 and locate the identified contextual support data 612 related to the object 122.

According to an example embodiment, the located contextual support data 612 related to the object 122 may then be sorted into separate categories, by the sorting module 550. The sorting action may be useful to determine in which section of the example sections 440 to 448 of the supplemental area 140 each category of the contextual support data 612 may be displayed. Examples of the categories are presented in the description of FIGS. 10-12 below.

The configuration module 560 may be used to configure the visual presentation of the contextual support data 612 in multiple sections of the supplemental area 140. The configuration module 560, may for example, determine the form of the display of the data in the supplemental area 140 (e.g., table, drop-down box, or the like, or the font type, font size, or other formatting characteristics of the presentation of the data).

Referring to FIG. 6 of the drawings, reference 600 generally indicates an example embodiment of a method to locate contextual support data related to an object 122. From among the data items data 1 (item 604) to data n (item 610) existing in the database 302, the look-up module 306 may identify the portion 612 as contextual support data related to the object 122. The contextual support data 612 may include, for example, data items data 2 (item 606) to data item data k (item 608).

FIG. 7 is a block diagram, illustrating an example embodiment of a method 700 to sort and configure contextual support data related to an object 122. The data items 606, 706, and 708 to 608 are parts of the contextual support data 612 related to the object 122. The sorting module 550 may determine the categories of the data items included in the contextual support data 612 (e.g., data items 706 and 708) may be of the same category and items 718 and 608 may each be determined to belong to separate categories. The configuration module 560 may determine in which section of the supplemental area 140 each data category may be directed to and in which form should each data category be displayed.

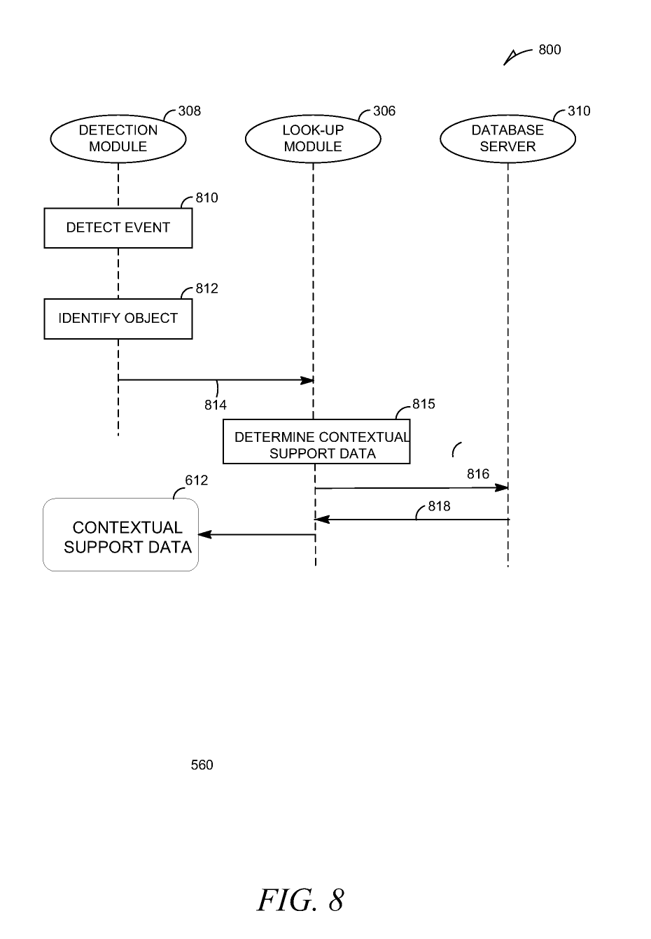

FIG. 8 is a sequential flowchart, and reference 800 indicates transactions between modules of a contextual support system. At first operation 810, the detection module 308 may detect an event related to the object 122 associated with the application 202. The detection module 308, at operation 812, may identify the object 122. The detection module 308 may then report an identity of the object 122 to the look-up module 306 (operation 814).

The look-up module 306 may determine the contextual support data 612 related to the object 122, according to a defined relationship (operation 815). At operation 816, the request for the contextual support data 612 may be submitted, through database server 310, to the database 302, to locate the contextual support data 612 on the database 302. The database server then, at operation 818, reports back the located contextual support data 612 to the look-up module 306. The contextual support data 612 may then be passed to the sorting module 550 to be sorted out into separate categories. The sorting action may be useful o determine in which section of the example sections 440 to 448 of the supplemental area 140 each category of the contextual support data 612 may be displayed.

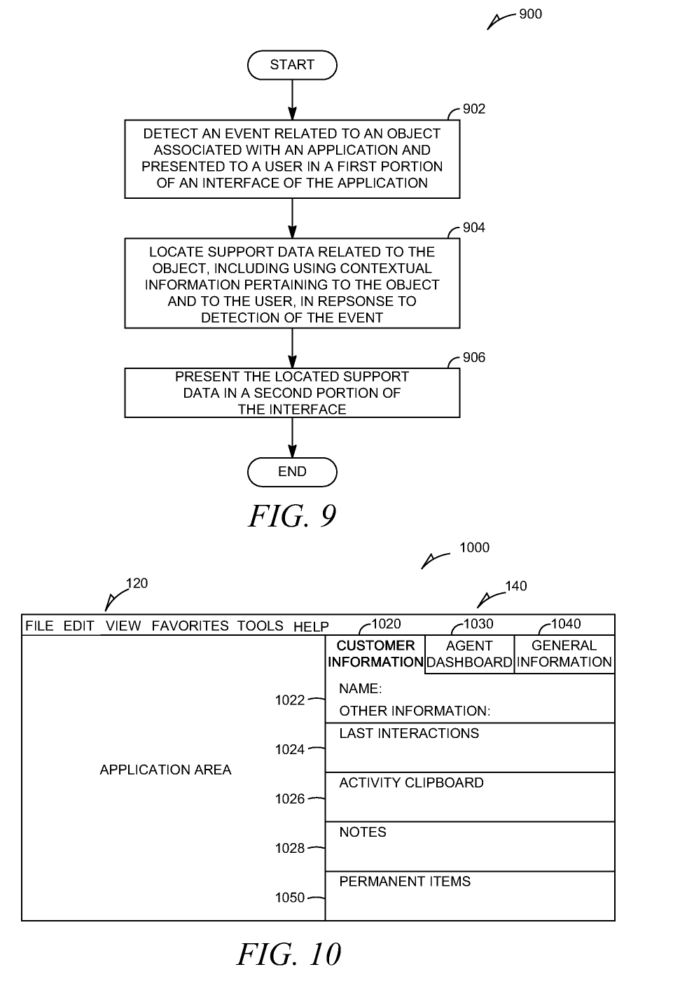

FIG. 9 is a flow diagram illustrating an example embodiment of a method 900 for providing contextual support data in an application. The example method 900 starts at operation 902 where an event related to the object 122, associated with the application 202 and presented to the user in the application area 120 via the user interface module 304, may be detected by the detection module 308.

At operation 904, in response to the detection by the detection module 308, the contextual support data 612 related to the object 122 may be located using contextual information pertaining to the object 122 and to the user. In example embodiments, the contextual support data may be contextual to a person or an attribute of the person (e.g., a task performed by the person or a role of the person in a work place). The person may be an agent of a workplace, such as but not limited to a business enterprise, a manufacturing facility, an academic or scientific institution, a health center, or the like. The support data may be contextual support data, meta-data, or historical data such as the previous activities of the agent related to his tasks.

In example embodiments, contextual information pertaining to the user may include any one of the user's name, an employee identification number associated with the user, a birthdate of the user, or the like. The contextual information pertaining to the object may include any attribute of the object, such as a date, a category, a type, a material, etc.

Returning to the method 900, at operation 906 the user interface module 304 may present the located contextual support data 612 to the user in the supplemental area 140 of the application interface 100.

Referring to FIG. 10 of the drawings, reference 1000 generally indicates a screen shot, illustrating an example embodiment of a user interface including a supplemental area configured to display three categories of support data.

In order to allow the end user to work in many environments with different screen resolutions, the supplemental area may, in one example deployment, not be used to provide task-critical information. It may be limited to the display of information usually hidden in navigational steps, modal or modeless dialogs, or that was not previously there.

Additionally, this may require that the data presented to the user interface 1000 is configured and structured by the configuration module 560 in reasonable chunks of information. The configuration module 560 may need to flag the chunks according to their importance to the end-user task.

Other than the task related information, an embodiment may be applied with respect to generic information, which is predesignated to be shown in the supplemental area 140. Examples of such generic information may be items such as search, help, personalization, favorites, etc., that are otherwise hidden in menus or somewhere else. Taking this into account, the supplemental area 140 may need to be able to switch between many different views to be sufficiently flexible.

The following example of a call center application may illustrate some of the example embodiments discussed here and. The use case that is illustrated in the following example may take the role of a call center agent and analyze the type of contextual support data 612 that might be useful while creating a sales order.

In the example use scenario, after the call center agent has accepted the call, the first operation is to identify the customer on the line in the system. Once this is done, the system may be able to provide information that may be related to the customer and useful for the call center agent in the ongoing task. In the case of the example below, the status of the customer (in this case Gold Customer) plus his interaction record of the activities pertaining to the customer and some notes that were previously taken may be provided in the supplemental area 140.

In the example use scenario of the call center, the supplemental area 140 may include a customer information view 1020, an agent dashboard view 1030, and a general information view 1040. The example user interface 1000 shows a situation in which the customer information view 1020 is active. The information is shown in five different sections. Section 1022 of the customer information view 1020 may include general information related to the customer, such as name, status (e.g. Gold), the sales points, qualification for discounts, etc.

Section 1024 of the customer information view 1020 may display last interactions (e.g., date, time, transaction number, and status/results). Section 1026 may be allocated to activity clipboard, where activities such as sales transactions and service progress are displayed. In section 1028 of the customer information view 1020, the agent notes are displayed.

The section 1050 at the bottom of the customer information view 1020 is used for permanent items. These items may be present regardless which view of the supplemental area 140 is active. In the example use scenario of call center, the “Broadcast Box” may be placed in this section. The Broadcast Box is used to push messages to all agents of a call center. The second item for this section may be a register with the names of all available second level agents and their awareness status and a quick dial option.

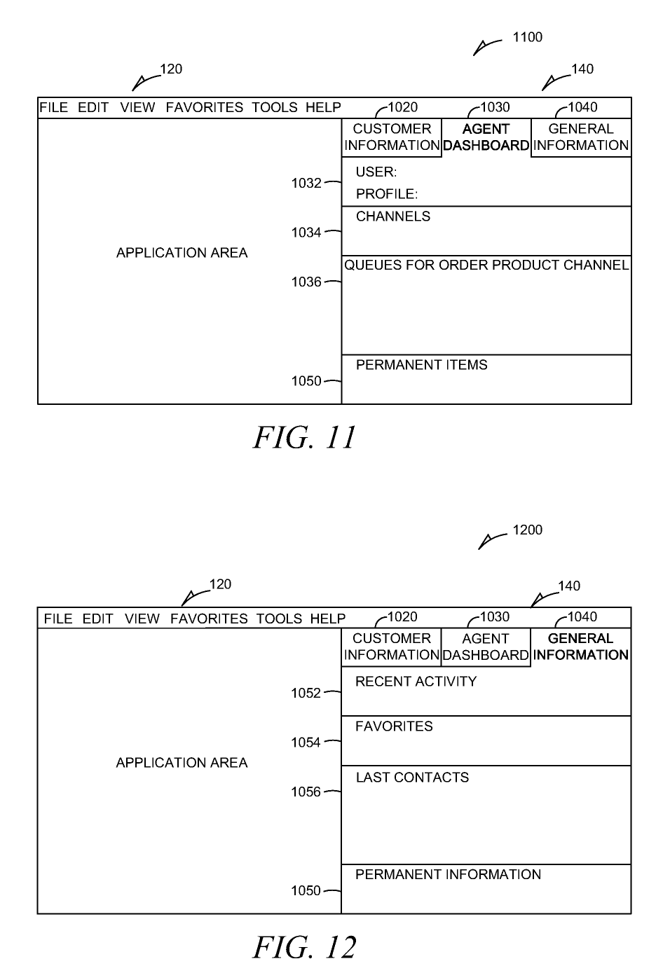

Referring to FIG. 11 of the drawings, reference 1100 generally shows a screen shot illustrating another example embodiment of a graphical user interface including a supplemental area configured to display three categories of support data. In this interface, the agent dashboard view 1030 is active. On section 1032, the user name and profile (e.g. position in the call center), may be displayed.

This view may also provide information regarding the work environment that may be useful to the user. In some call centers, this is projected to a wall. For example, the agent dashboard view 1030 may, in section 1034, show the channels of the call center and their actual utilization to give a hint about the overall workload to the agent. For example the section may display order names (e.g., order status, order change, repairs, returns, etc.), and the statutes of orders (e.g., low, moderate, elevated, decreased, and high).

In section 1036 of the agent dashboard view 1030, queues for order product channel may be shown. For example, the view in this section may display information such as call numbers and locations and time on hold for all callers in the queue.

Referring to FIG. 12 of the drawings, reference 1200 shows a screen shot illustrating another example embodiment of a graphical user interface including a supplemental area configured to display three categories of support data. In this interface, the general information view 1040 is active, where a set of generic information that may be useful to any end-user and may function mainly as an external memory with a quick access to recent objects/activities, favorites, and contacts may be displayed.

The example general information view 1040 may include sections 1052, 1054, 1056, and 1050. Section 1052 may display recent activities (e.g., dates, times, and descriptions of various activities). In section 1054, favorite items (e.g., product look up, identify account, interaction records, etc.) may be shown in hypertext format. In the example, last contacts section 1056 may display items such as ranks, names, and telephone number of the customers.

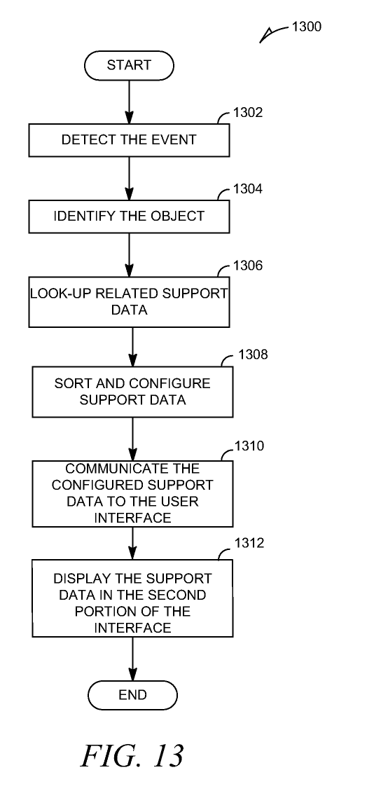

FIG. 13 of the drawings shows a flow diagram 1300 illustrating an example embodiment of a method 1300 for providing contextual support data in an application, including sorting and configuring the support data. The example method 1300 may start at operation 1302 where an event related to an object 122 of the application 202 is detected by the detection module 308 and identified (operation 1304).

In example embodiments, the event may include a mouseover on object 122 of the application area 120; a mouse click over the object 122; pressing a predetermined key, receiving a content in a certain box on the application area 120; receiving a wrong content in a certain box on the application area 120; or receiving a predetermined voice message from a user identifying the object. The object 122 may be any object for which the contextual support data 612 may be provided in the supplemental area 140 of the application interface 100.

At operation 1306, the look-up module 306 may search the database 302 to locate the contextual support data 612 associated with the object 122. The contextual support data 612 is then received by the sorting modules 550 to be sorted into separate categories (operation 1308). For example, the sorting action may be necessary to determine in which view of the example views 1020, 1030, or 1040 of the supplemental area 140 (see FIG. 12) each category of the contextual support data 612 may be displayed.

Operation 1308 may also include configuring the visual presentation of the contextual support data 612 in multiple sections of the supplemental area 140. The configuration module 560, may for example, determine the form of the display of the data in various sections of the supplemental area 140 (e.g., table, drop-down box, or the like, or the font type, font size, or other formatting characteristics of the presentation of the data).

Following sorting and configuration operation 1308, the user interface module 304 may receive at operation 1310 the sorted and configured contextual support data 612 to be displayed in the supplemental area 140. At operation 1312, the user interface module 304 may display the sorted and configured contextual support data in proper sections. In the example embodiment of FIG. 12, the contextual support data is first sorted into three main categories and shown in three distinct views (e.g., customer information 102, agent dashboard 1030, and general information 1040). Each of these views may then be sorted in sub-categories as shown in FIG. 12, for example, recent activities 1052, favorites 1054, last contacts 1056, and permanent information 1050.

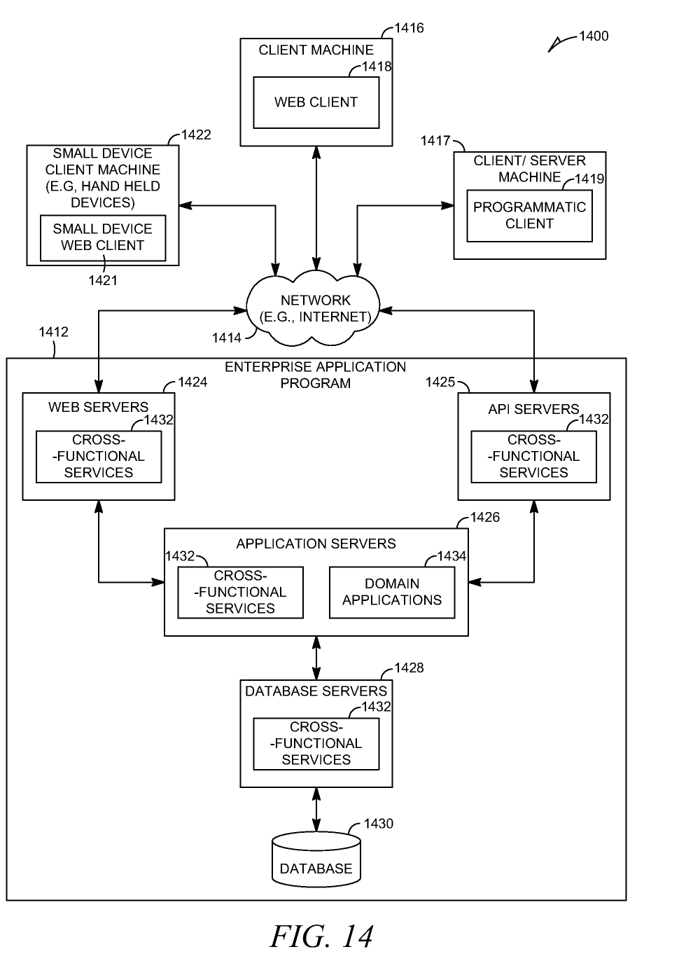

FIG. 14 is a network diagram depicting a system 1400, according to one example embodiment, having client-server architecture. A platform (e.g., machines and software) in the example form of an enterprise application platform 1412, may provide server-side functionality, via a network 1414 (e.g., the Internet) to one or more clients. FIG. 14 illustrates, for example, a client machine 1416 with Web client 1418 (e.g., a browser, such as the INTERNET EXPLORER browser developed by Microsoft Corporation of Redmond, Wash.), a small device client machine 1422 with a small device web client 1421 (e.g., a browser without a script engine), and a client/server machine 1417 with a programmatic client 1419.

Turning specifically to the enterprise application platform 1412, Web servers 1424, and Application Program Interface (API) servers 1425 are coupled to, and may provide Web and programmatic interfaces to, application servers 1426. The application servers 1426 are, in turn, shown to be coupled to one or more databases servers 1428 that facilitate access to one or more databases 1430. The Web servers 1424, Application Program Interface (API) servers 1425, application servers 1426, and database servers 1428 host cross-functional services 1432. The application servers 1426 further hosts domain applications 1434.

The cross-functional services 1432 may provide services to users and processes that use the enterprise application platform 1412. For instance, the cross-functional services 1432 may provide portal services (e.g., Web services), database services, and connectivity to the domain applications 1434 for users that operate the client machine 1416, the client/server machine 1417, and the small device client machine 1422. In addition, the cross-functional services 1432 may provide an environment for delivering enhancements to existing applications and for integrating third-party and legacy applications with existing cross-functional services 1432 and domain applications 1434. Furthermore, while the system 1400 shown in FIG. 14 employs client-server architecture, the present invention is of course not limited to such an architecture and could equally well find applications in a distributed, or peer-to-peer architecture system.

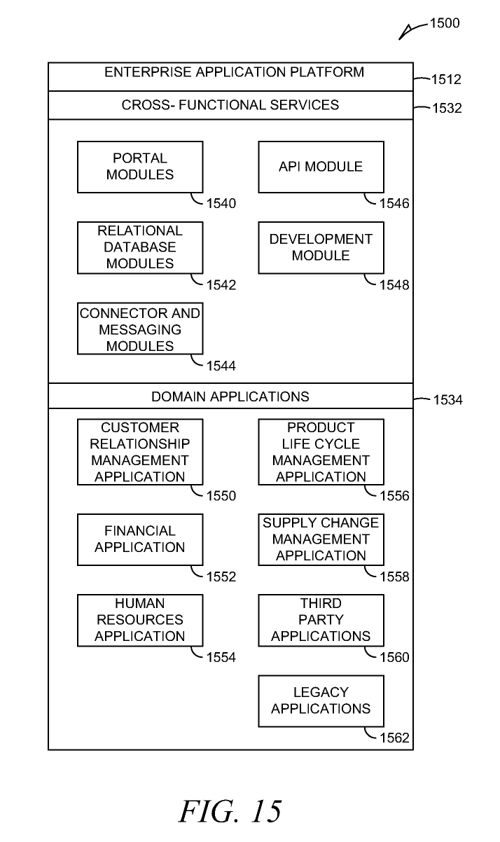

FIG. 15 is a block diagram illustrating enterprise applications and services as embodied in the enterprise application platform 1412, according to an example embodiment. The enterprise application platform 1412 may include cross-functional services 1532 and domain applications 1434. The cross-functional services 1432 may include portal modules 1540, relational database modules 1542, connector and messaging modules 1544, Application Program Interface (API) modules 1546, and development modules 1548.

The portal modules 1540 may enable a single point of access to other cross-functional services 1432 and domain applications 1434 for the client machine 1416, the small device client machine 1422, and the client/server machine 1417. The portal modules 1440 may be used to process, author, and maintain Web pages that present content (e.g., user interface elements and navigational controls) to the user. In addition, the portal modules 1540 may enable user roles, a construct that associates a role with a specialized environment that may be used by a user to execute tasks, use services, and exchange information with other users and within a defined scope. For example, the role may determine the content that is available to the user and the activities the user may perform. In addition, the portal modules 1540 may comply with Web services standards and/or use a variety of Internet technologies including Java, J2EE, SAP's Advanced Business Application Programming Language (ABAP) and Web Dynpro, XML, JCA, JAAS, X.509, LDAP, WSDL, WSRR, SOAP, UDDI, and Microsoft .NET.

The relational database modules 1542 may provide support services for access to the database 1430 that includes a user interface library 1436. The relational database modules 1542 may provide support for object relational mapping, database independence, and distributed computing. The relational database modules 1542 may be used to add, delete, update, and manage database elements. In addition, the relational database modules 1542 may comply with database standards and/or use a variety of database technologies including SQL, SQLDBC, Oracle, MySQL, Unicode, and JDBC.

The connector and messaging modules 1544 may enable communication across different types of messaging systems that are used by the cross-functional services 1432 and the domain applications 1434 by providing a common messaging application processing interface. The connector and messaging modules 1544 may enable asynchronous communication on the enterprise application platform 1412.

The Application Program Interface (API) modules 1546 may enable the development of service-based applications by exposing an interface to existing and new applications as services. Repositories may be included in the platform as a central place to find available services when building applications.

The development modules 1548 may provide a development environment for the addition, integration, updating, and extension of software components on the enterprise application platform 1412 without affecting existing cross-functional services 1432 and domain applications 1434.

Turning to the domain applications 1434, the customer relationship management applications 1550 may enable access to and facilitate collecting and storing of relevant personalized information from multiple data sources and business processes. Enterprise personnel that are tasked with developing a buyer into a long-term customer may use the customer relationship management applications 1550 to provide assistance to the buyer throughout a customer engagement cycle.

Enterprise personnel may use the financial applications 1552 and business processes to track and control financial transactions within the enterprise application platform 1412. The financial applications 1552 may facilitate the execution of operational, analytical, and collaborative tasks that are associated with financial management. Specifically, the financial applications 1552 may enable the performance of tasks related to financial accountability, planning, forecasting, and managing the cost of finance.

The human resource applications 1554 may be used by enterprise personal and business processes to manage, deploy, and track enterprise personnel. Specifically, the human resource applications 1554 may enable the analysis of human resource issues and facilitate human resource decisions based on real-time information.

The product life cycle management applications 1556 may enable the management of a product throughout the life cycle of the product. For example, the product life cycle management applications 1556 may enable collaborative engineering, custom product development, project management, asset management, and quality management among business partners.

The supply chain management applications 1558 may enable monitoring of performances that are observed in supply chains. The supply chain management applications 1558 may facilitate adherence to production plans and on-time delivery of products and services.

The third-party applications 1560, as well as legacy applications 1562, may be integrated with domain applications 1434 and use cross-functional services 1432 on the enterprise application platform 1412.

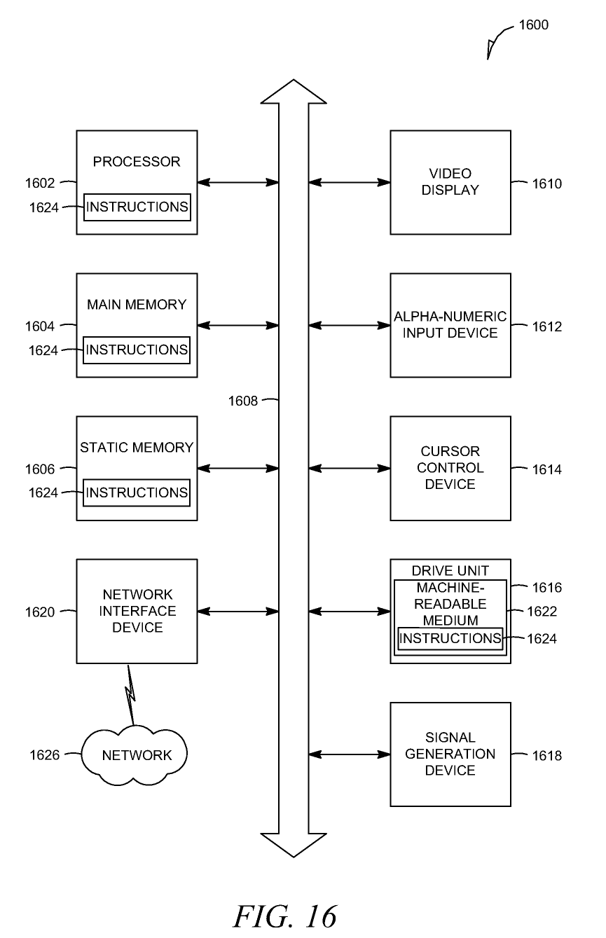

FIG. 16 shows a diagrammatic representation of a machine in the example form of a computer system 1600 within which a set of instructions, for causing the machine to perform any one or more of the methodologies discussed herein, may be executed. In alternative embodiments, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1600 includes a processor 1602 (e.g., a central processing unit (CPU), a graphics processing unit (GPU) or both), a main memory 1604 and a static memory 1606, which communicate with each other via a bus 1608. The computer system 1600 may further include a video display unit 1610 (e.g., a liquid crystal display (LCD) or a cathode ray tube (CRT)). The computer system 1600 may also include an alphanumeric input device 1612 (e.g., a keyboard), a user interface (UI) navigation device 1614 (e.g., a mouse), a disk drive unit 1616, a signal generation device 1618 (e.g., a speaker), and a network interface device 1620.

The disk drive unit 1616 may include a machine-readable medium 1622 on which is stored one or more sets of instructions and data structures (e.g., software 1624) embodying or utilized by any one or more of the methodologies or functions described herein. The software 1624 may also reside, completely or at least partially, within the main memory 1604 and/or within the processor 1602 during execution thereof by the computer system 1600, the main memory 1604 and the processor 1602 also constituting machine-readable media.

The software 1624 may further be transmitted or received over a network 1626 via the network interface device 1620 utilizing any one of a number of well-known transfer protocols (e.g., HTTP).

While the machine-readable medium 1622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Thus, a method and system to provide contextual support data are described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method comprising:
detecting an event related to an object associated with an application and presented to a user in a first portion of an interface of the application;
responsive to the detecting of the event, locating support data related to the object, the locating of the support data including using contextual information pertaining to the object and to the user; and
presenting, in a second portion of the interface, the located support data related to the object.

2. The method of claim 1, wherein the detecting of the event includes a user interaction with the interface of the application.

3. The method of claim 1, wherein the locating of the support data comprises locating at least one of contextual data, meta-data, or historical data.

4. The method of claim 1, wherein the object comprises at least one of:
an attribute of the first portion of the interface,
a data item included in the first portion of the interface,
a person identified in the first portion of the interface, or
a person associated with a data item included in the first portion of the interface.

5. The method of claim 1, wherein the support data is contextual to at least one of a person or an attribute of the person.

6. The method of claim 1, wherein the contextual information pertaining to the user comprises at least one of a role attribute of the user, an attribute of a work environment of the user, or historical data associated with the user.

7. The method of claim 1, further comprising sorting the support data and configuring the support data for display in the second portion of the interface.

8. The method of claim 1, further comprising displaying the second portion of the interface without overlapping the first portion and in a fixed position relative to the first portion.

9. The method of claim 1, wherein a relation between the support data and the object is dynamic.

10. A system comprising:
a user interface module to present an interface, the interface including a first portion and a second portion,
a detection module to detect an event related to an object presented to a user in the first portion of the interface;
a look-up module to locate, responsive to the detection of the event, support data related to the object, the locating of the support data including using contextual information pertaining to the object and to the user; and
the user interface module to present, in the second portion of the interface, the located support data related to the object.

11. The system of claim 10, wherein the detection module is to detect an event, the event including a user interaction with the interface of the application.

12. The system of claim 10, wherein the look-up module is to recognize the support data as including contextual data, meta-data, and historical data.

13. The system of claim 10, wherein the object comprises at least one of:
an attribute of the first portion of the interface,
a data item included in the first portion of the interface,
a person identified in the first portion of the interface, or
a person associated with a data item included in the first portion of the interface.

14. The system of claim 10, wherein a relation between the support data and the object is dynamic.

15. The system of claim 10, further comprising a database to maintain data and a database server to facilitate accessing the database.

16. The system of claim 10, wherein the support data is contextual to at least one of a person or an attribute of the person.

17. The system of claim 10, wherein the contextual information pertaining to the user comprises at least one of a role attribute of the user, an attribute of a work environment of the user, or historical data associated with the user.

18. The system of claim 10, further comprising an analysis module to analyze the object in order to determine a category of the contextual information pertaining to the object.

19. A machine-readable medium embodying instructions, the instructions, when executed by a machine, causing the machine to:
detect an event related to an object associated with an application and presented to a user in a first portion of an interface of the application;
responsive to the detection of the event, locate support data related to the object, the locating of the support data including using contextual information pertaining to the object and to the user; and
present, in a second portion of the interface, the located support data related to the object.

20. A system comprising:
means for detecting an event related to an object associated with an application and presented to a user in a first portion of an interface of the application;
means for locating support data related to the object, responsive to the detecting the event, the locating of the support data including using contextual information pertaining to the object and to the user; and
means for presenting, in a second portion of the interface, the located support data related to the object.
